(19) United States
(12) Patent Application Publication
(10) Pub. No.: US 2016/0242181 A1
(43) Pub. Date: Aug. 18, 2016

(54) Managing Throughput-Based Tune-Away Carrier Selection

(71) Applicant: QUALCOMM Incorporated, San Diego, CA (US)

(72) Inventors: Dhananjaya Sarma Ponukumati, Hyderabad (IN); Anand Rajurkar, Hyderabad (IN)

(21) Appl. No.: 14/624,780

(22) Filed: Feb. 18, 2015

(51) Int. Cl. H04W 72/04; H04W 24/08

(52) U.S. Cl. CPC H04W 72/0453; H04W 24/08; H04W 72/0473

(57) ABSTRACT

Embodiments include systems and methods for managing tune away in a multi-subscription communication device. A processor of a multi-subscription communication device may determine a first throughput of a first carrier signal and a second throughput of a second carrier signal. The processor may perform a tune-away procedure to a carrier signal having a lower throughput from among the first carrier signal and the second carrier signal.

### BACKGROUND

Wireless devices having multiple subscriber identity modules (SIMs) may communicate with two or more cells of a wireless network. Some multi-subscription communication devices may allow two or more network interfaces or subscriber identity modules (SIMs) to share a single radio frequency (RF) resource (e.g., dual SIM dual standby or “DSDS”). However, the RF resource in such devices can only tune to a single network at a time. The multi-subscription communication device may employ a “tune-away” procedure to monitor multiple interfaces in a standby mode by tuning to one network in a primary cell, quickly tuning away to the secondary network in a secondary cell for a short time, and then tuning back to the first network to continue a voice or data call. This tune-away procedure may allow the multi-subscription communication device to monitor for pages or other indications of incoming messages or data received on the secondary network. However, tuning away to another network may interrupt communications with the first network, and may reduce throughput of communications between the first network and the multi-subscription communication device.

Certain communication protocols, such as the 3GPP Long Term Evolution (LTE)-Advanced protocol, permit carrier aggregation (CA) in which a wireless device may schedule data traffic over multiple carrier bands (referred to as component carriers) to increase available bandwidth, and thus throughput, for voice and data communication. Carrier aggregation may be performed in the uplink (UCLA) and/or the downlink (DLCA), and may be performed using a varying number of component carriers (N number of component carriers, or NxCA). Currently, the tune-away procedure is always performed in the secondary cell. This is inefficient because the tune-away procedure does not account for varying throughput that may be provided by cell signals between the multi-subscription communication device and the primary and secondary cells. For example, when a throughput over signals with the secondary cell are superior to a throughput over signals with the primary cell, performing the tune-away procedure in the secondary cell will reduce overall throughput for an active communication session more than if the tune-away procedure were performed in the primary cell.

### SUMMARY

Systems, methods, and devices of various embodiments enable a multi-subscription communication device having a plurality of RF resources to manage a tune-away procedure. Various embodiments may include determining a first throughput of a first carrier signal and a second throughput of a second carrier signal and performing a tune-away procedure to a carrier signal determined to have a lower throughput from among the first carrier signal and the second carrier signal. In some embodiments, determining a first throughput of a first carrier signal and a second throughput of a second carrier signal may include determining the first throughput and the second throughput just prior to the tune-away procedure. In some embodiments, determining a first throughput of a first carrier signal and a second throughput of a second carrier signal may be independent of a signal strength of either the first carrier signal or the second carrier signal.

In some embodiments, determining a first throughput of a first carrier signal and a second throughput of a second carrier signal may include determining a first throughput for each component carrier of the first carrier signal and determining a second throughput for each component carrier of the second carrier signal, respectively. In some embodiments, determining a first throughput of a first carrier signal and a second throughput of a second carrier signal may include determining a first average throughput of the first carrier signal and determining a second average throughput of the second carrier signal, respectively. In some embodiments, determining a first throughput of a first carrier signal and a second throughput of a second carrier signal may include determining a first average throughput for each component carrier of the first carrier signal and determining a second average throughput for each component carrier of the second carrier signal, respectively.

In some embodiments, determining a first throughput of a first carrier signal and a second throughput of a second carrier signal may include determining a first throughput per time transmission interval (TTI) for the first carrier signal and determining a second throughput per TTI for the second carrier signal, respectively. In some embodiments, determining a first throughput per TTI for the first carrier signal and determining a second throughput per TTI for the second carrier signal may include determining a first average throughput per TTI for each component carrier of the first carrier signal and determining a second average throughput per TTI for each component carrier of the second carrier signal, respectively.

Some embodiments may further include determining a first transmit power requirement of the first carrier signal and a second transmit power requirement of the second carrier signal, wherein performing a tune-away procedure to a carrier signal determined to have a lower throughput from among the first carrier signal and the second carrier signal may include performing a tune-away procedure to a carrier signal determined to have at least one of a lower throughput and a higher transmit power requirement from among the first carrier signal and the second carrier signal.

Various embodiments may include a mobile communication device including a processor configured with processor-executable instructions to perform operations of the embodiment methods described above. Various embodiments may include a mobile communication device that includes means for performing functions of the operations of the embodiment methods described above. Various embodiments may include a non-transitory processor-readable storage medium having stored thereon processor-executable software instructions configured to cause a processor of a mobile communication device to perform operations of the embodiment methods described above.

### BRIEF DESCRIPTION OF THE DRAWINGS

The accompanying drawings, which are incorporated herein and constitute part of this specification, illustrate exemplary embodiments. Together with the general description given above and the detailed description given below, the drawings serve to explain features of the various embodiments, and not to limit the various embodiments.

FIG. 1 is a component block diagram of a communication system suitable for use with various embodiments.

FIG. 2 is a component block diagram of a multi-subscription communication device according to various embodiments.

FIG. 3 is a process flow diagram illustrating a method for managing tune away in a multi-subscription communication device according to various embodiments.

FIG. 4 is a process flow diagram illustrating another method for managing tune away in a multi-subscription communication device according to various embodiments.

FIG. 5 is a process flow diagram illustrating another method for managing tune away in a multi-subscription communication device according to various embodiments.

FIG. 6 is a component block diagram of a mobile communication device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

The terms “multi-subscription communication device,” “wireless device,” “communication device,” and “mobile communication device” are used interchangeably herein to refer to any one or all of cellular telephones, smartphones, personal or mobile multi-media players, personal data assistants (PDAs), laptop computers, tablet computers, smartbooks, palmtop computers, wireless electronic mail receivers, multimedia Internet enabled cellular telephones, wireless gaming controllers, and similar electronic devices and portable computing platforms which include a programmable processor and a memory. Various embodiments may be particularly useful in any communication devices that use multiple radio access protocols to communicate with a communication network.

The terms “component,” “module,” “system,” and the like as used herein are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

A multi-subscription communication device may communicate with two or more cells of a wireless network. Some multi-subscription communication devices may allow two or more network interfaces or SIMs to share a single RF resource. However, the RF resource in such devices can only tune to a single network at a time. The multi-subscription communication device may employ a tune-away procedure to monitor multiple interfaces in a standby mode by tuning to one network (i.e., tuning to one carrier signal associated of the network), quickly tuning away to the secondary network for a short time (i.e., tuning to another carrier signal of the secondary network), and then tuning back to the first network to continue a voice or data call. This tune-away procedure allows the multi-subscription communication device to monitor for pages or other indications of incoming messages or data received on the secondary network. Different radio access technologies (RATs) may be used in the different networks. For example, in some implementations, the voice or data call may use 3GPP Long Term Evolution (LTE), and the tune-away procedure may be performed using Global System for Mobility (GSM). The timing of each tune-away procedure is typically specified by a radio access protocol (e.g., LTE or GSM). Tuning away to another network may interrupt transmissions to the first network, and may reduce throughput of data transmitted between the first network and the multi-subscription communication device.

Currently, the tune-away procedure is always performed (i.e., statically performed) in the secondary cell (i.e., to a carrier signal of the secondary cell). Such performance is inefficient because tuning away to the secondary cell does not account for varying throughput provided by the communication signals (i.e., carrier signals) of the primary and secondary cells. For example, when the throughput of the communication signals of the secondary cell are superior to that in the primary cell (i.e., the throughput of a secondary cell carrier signal is superior to the throughput of a primary cell carrier signal), performing a tune away in the secondary cell will reduce the overall throughput for the active communication session more than if the tune away were performed in the primary cell.

“Throughput” refers to an amount of data transmitted or transported from one network element to another network element, such as between a base station or access point and a receiving device, or between a network server and a communication device. The throughput provided by a carrier signal or communication signal may be independent of other characteristics of the carrier signal, such as signal strength, signal quality, and other similar signal characteristics. For example, a communication device may determine that a first carrier signal has a higher signal strength than a second carrier signal for a variety of reasons, including the communication device being closer to a first carrier signal's transmitter, or because the first carrier signal is broadcast at a higher transmit power than the second carrier signal. However, the second carrier signal may provide a higher throughput than the first carrier signal, because the first carrier signal is more heavily loaded than the second carrier signal (i.e., is serving a greater number of communication devices or is subject to greater scheduling demands than the second carrier signal), or because the second carrier signal can support a higher modulation and coding scheme (MCS), or for another reason. Thus, a throughput of a carrier signal may be determined independent of, and in some cases may be contrary to, signal strength, signal quality, or other similar signal characteristics.

In various embodiments, a multi-subscription communication device may select one of a first carrier signal and a second carrier signal in which to perform the tune-away procedure based on the calculated throughputs of a signal from each carrier signal so as to improve overall data throughput for the multi-subscription communication device during the period of the tune-away procedure. The tune-away procedure may be performed periodically at times typically dictated by the RAT. Just prior to each tune-away procedure, the multi-subscription communication device may determine a throughput of a carrier signal in each of the two carrier signals. Based on the determined throughputs of the first carrier signal and the second carrier signal, the multi-subscription communication device may select the carrier signal with the lower throughput, and perform the tune-away procedure with the selected carrier signal. During the tune-away procedure, the multi-subscription communication device may tune away a wireless transceiver of the multi-subscription communication device that corresponds to the selected carrier signal. In various embodiments, while the first and second carrier signals may use a first RAT, the multi-subscription communication device may use a second RAT for the tune-away procedure. The various embodiments may be of particular use in evaluating a slow fading channel, e.g., due to communication device mobility, or changing RF conditions that may affect channel throughput, or changing network traffic or scheduling conditions that may affect carrier signal throughput.

The various embodiments may also be used when the multi-subscription communication device is configured to use carrier aggregation in the first and second carrier signals in order to improve data transfer rates. Some RATs, such as LTE-Advanced, enable the use of carrier aggregation (also referred to as channel aggregation) in which more than one portion of a frequency band, or portions of different frequency bands (each portion being referred to as a “component carrier”) may be used to send and receive communications in an aggregated channel in order to increase overall communication bandwidth. Carrier aggregation may be performed intra-band (using contiguous or non-contiguous component carriers) or inter-band. The number of component carriers used for carrier aggregation may vary according to the RAT. For example, LTE-Advanced may enable up to five 20 MHz carriers to be aggregated. One component carrier may be designated the primary component carrier, and may have an associated uplink primary component carrier. The remaining component carriers may be designated secondary component carriers. The primary component carrier is typically the main downlink carrier. The designation of primary and second component carriers is typically cell specific.

In various embodiments, when carrier aggregation is used in each cell, the multi-subscription communication device may determine the throughput of each component carrier in each carrier signal. Considering the throughput of each component carrier of each carrier signal, the multi-subscription communication device may select the carrier signal with the lowest throughput of each carrier signal in which to perform the tune-away procedure, and the multi-subscription communication device may tune away the wireless transceiver corresponding to the carrier signal with the lowest throughput. This may enable the carrier signal with stronger component carrier(s) to continue to be used for receiving data during the tune-away procedure.

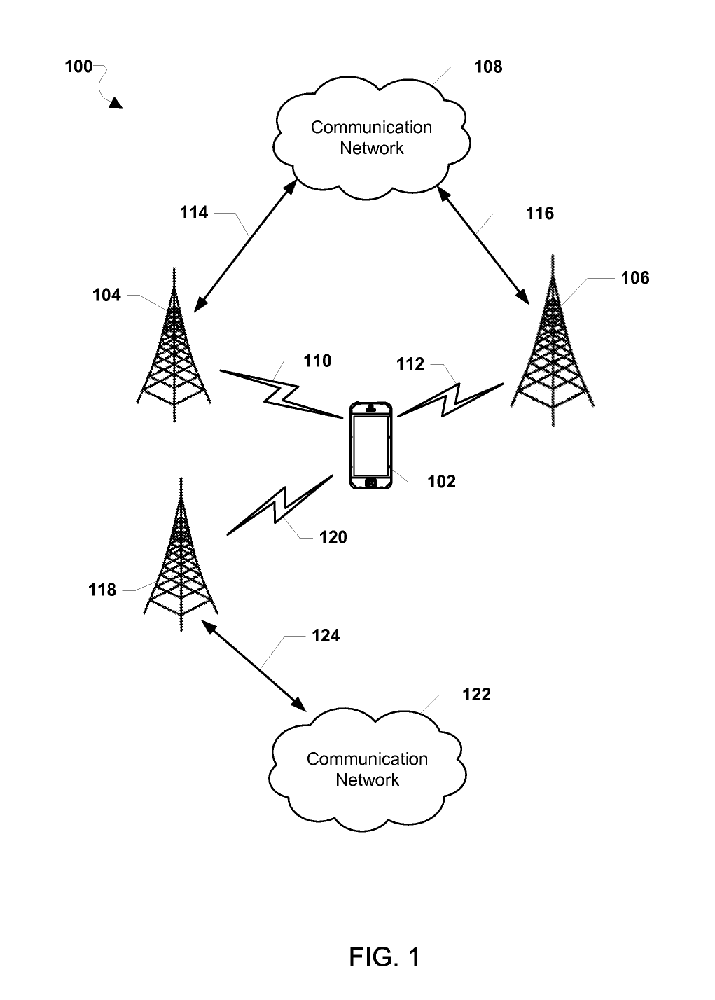

Various embodiments may be implemented in multi-subscription communication devices that may operate within a variety of communication systems particularly systems that include at least two communication networks. FIG. 1 illustrates a communication system 100 suitable for use with various embodiments. A multi-subscription communication device 102 may communicate with a communication network 108, which may include a plurality of base stations, such as base stations 104, 106. The multi-subscription communication device 102 may also communicate with a communication network 122, which may include a base station 118. The base station 104 may communicate with the communication network 108 over a wired or wireless communication link 114, which may include fiber optic backhaul links, microwave backhaul links and other similar communication links. The base station 106 may communicate with the communication network 108 over a wired or wireless communication link 116 similar to the communication link 114. The base station 118 may communicate with the communication network 122 over a wired or wireless communication link 124 similar to the communication link 114. In some embodiments, each communication network 108, 122 may include a mobile telephony communication network. The multi-subscription communication device 102 may communicate with the base station 104 over a wireless communication link 110, with the base station 106 over a wireless communication link 112, and with the base station 118 over a wireless communication link 120.

Each of the communication networks 108, 122 may support communications using one or more RATs, and each of the wireless communication links 110, 112, and 120 may include cellular connections that may be made through two-way wireless communication links using one or more RATs. Examples of RATs may include LTE, Worldwide Interoperability for Microwave Access (WiMAX), Code Division Multiple Access (CDMA), Time Division Multiple Access (TDMA), Wideband CDMA (WCDMA), GSM, and other RATs. While the communication links 110, 112, and 120 are illustrated as single links, each of the communication links 110, 112, and 120 may include a plurality of carrier signals, frequencies or frequency bands, each of which may include a plurality of logical channels. Additionally, each of the communication links 110, 112, and 120 may utilize more than one RAT. For example, the multi-subscription communication device 102 may receive a first carrier signal from the base station 104 and a second carrier signal from the base station 106, and the multi-subscription communication device 102 may determine a throughput each of the carrier signals. As another example, the multi-subscription communication device 102 may receive the first carrier signal and the second carrier signal from the base station 104 or the base station 106. The multi-subscription communication device 102 may use a receiver or transceiver associated with the carrier signal having the lowest throughput from among the first carrier signal and the second carrier signal to perform the tune-away procedure. In some embodiments, the first and second carrier signals may use a first RAT. In some embodiments, the multi-subscription communication device 102 may also perform a tune-away procedure using a second RAT.

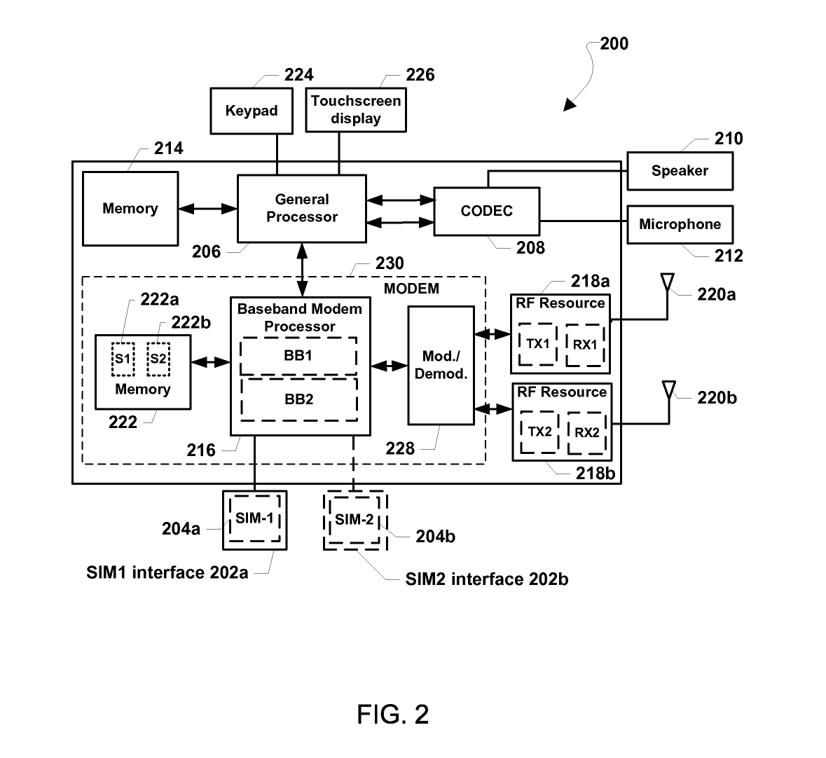

FIG. 2 is a component block diagram of a multi-subscription communication device 200 suitable for implementing various embodiments. In various embodiments, the multi-subscription communication device 200 may be similar to the multi-subscription communication device 102 as described with reference to FIG. 1. With reference to FIGS. 1 and 2, the multi-subscription communication device 200 may include a first SIM interface 202a, which may receive a first identity module SIM-1 204a that is associated with a first subscription. The multi-subscription communication device 200 may optionally also include a second SIM interface 202b, which may receive a second identity module SIM-2 204b that is associated with a second subscription. A SIM in various embodiments may be a Universal Integrated Circuit Card (UICC) that is configured with SIM and/or USIM (Universal Subscriber Identity Module) applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. Each SIM card may have a CPU, ROM, RAM, EEPROM and I/O circuits. A SIM used in various embodiments may contain user account information, an international mobile subscriber identity (IMSI), a set of SIM application toolkit (SAT) commands and storage space for phone book contacts. A SIM card may further store a Home-Public-Land-Mobile-Network (HPLMN) code to indicate the SIM card network operator provider. An Integrated Circuit Card Identity (ICCID) SIM serial number may be printed on the SIM card for identification.

The multi-subscription communication device 200 may include at least one controller, such as a general purpose processor 206, which may be coupled to a coder/decoder (CODEC) 208. The CODEC 208 may in turn be coupled to a speaker 210 and a microphone 212. The general purpose processor 206 may also be coupled to at least one memory 214. The memory 214 may be a non-transitory computer-readable storage medium that stores processor-executable instructions. The memory 214 may store an operating system (OS), as well as user application software and executable instructions. The memory 214 may also store application data, such as an array data structure.

The general purpose processor 206 may be coupled to a modem 230. The modem 230 may include at least one baseband modem processor 216, which may be coupled to a memory 222 and a modulator/demodulator 228. The baseband modem processor 216 may include physically or logically separate baseband modem processors (e.g., BB1, BB2). The modulator/demodulator 228 may receive data from the baseband modem processor 216 and may modulate a carrier signal with encoded data and provide the modulated signal to one or more RF resources 218a, 218b for transmission. The modulator/demodulator 228 may also extract an information-bearing signal from a modulated carrier wave received from the one or more RF resources 218a, 218b, and may provide the demodulated signal to the baseband modem processor 216. The modulator/demodulator 228 may be or include a digital signal processor (DSP).

The baseband modem processor 216 may read and write information to and from the memory 222. The memory 222 may also store instructions associated with a protocol stack, such as protocol stack S1 222a and protocol stack S2 222b. The protocol stacks S1 222a, S2 222b generally include computer executable instructions to enable communication using a radio access protocol or communication protocol. Each protocol stack S1 222a, S2 222b typically includes network protocol layers structured hierarchically to provide networking capabilities. The modem 230 may include one or more of the protocol stacks S1 222a, S2 222b to enable communication using one or more RATs. The protocol stacks S1 222a, S2 222b may be associated with a SIM card (e.g., SIM-1 204a, SIM-2 204b) configured with a subscription. For example, the protocol stack S1 222a and the protocol stack S2 222b may be associated with the SIM-1 204a. The illustration of only two protocol stacks S1 222a, S2 222b is not intended as a limitation, and the memory 222 may store more than two protocol stacks (not illustrated).

Each SIM and/or RAT in the multi-subscription communication device 200 (e.g., SIM-1 204a, SIM-2 204b) may be coupled to the modem 230 and may be associated with or permitted to use an RF resource. The term “RF resource” is used herein to refer to all of the circuitry used to send and receive RF signals, which may include the baseband modem processor 216 that performs baseband/modem functions for communicating with/controlling a RAT, one or more radio units including transmitter and receiver components that are shown as RF resources 218a, 218b (e.g., in FIG. 2), one or more of the wireless antennas 220a, 220b, and additional circuitry that may include one or more amplifiers and radios. In some embodiments, an RF resource may share a common baseband modem processor 216 (i.e., a single device that performs baseband/modem functions for all RATs on the multi-subscription communication device). In some embodiments, each RF resource may include the physically or logically separate baseband processors (e.g., BB1, BB2).

The RF resources 218a, 218b may be transceivers associated with one or more RATs and may perform transmit/receive functions for the mobile communication device 200 on behalf of their respective RATs. The RF resources 218a, 218b may include separate transmit and receive circuitry. In some embodiments, the RF resource 218b may include only receive circuitry. The RF resources 218a, 218b may each be coupled to a wireless antenna (e.g., the first wireless antenna 220a and the second wireless antenna 220b). The RF resources 218a, 218b may also be coupled to the baseband modem processor 216.

In some embodiments, the general purpose processor 206, memory 214, baseband processor(s) 216, and the RF resources 218a, 218b may be included in the mobile communication device 200 as a system-on-chip. In some embodiments, the first and second SIMs 204a, 204b and their corresponding interfaces 202a, 202b may be external to the system-on-chip. Further, various input and output devices may be coupled to components on the system-on-chip, such as interfaces or controllers. Example user input components suitable for use in the mobile communication device 200 may include, but are not limited to, a keypad 224 and a touchscreen display 226.

In some embodiments, the keypad 224, the touchscreen display 226, the microphone 212, or a combination thereof may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or receive a telephone number. As another example, the request to initiate the outgoing call may be in the form of a voice command received via the microphone 212. Interfaces may be provided between the various software modules and functions in the multi-subscription communication device 200 to enable communication between them.

Functioning together, the two SIMs 204a, 204b, the baseband processor(s) 216, RF resources 218a, 218b and the antennas 220a, 220b may enable communications on two or more RATs. For example, one SIM, baseband processor and RF resource may be configured to support two different RATs. In other embodiments, more RATs may be supported on the multi-subscription communication device 200 by adding more SIM cards, SIM interfaces, RF resources, and antennas for connecting to additional mobile networks.

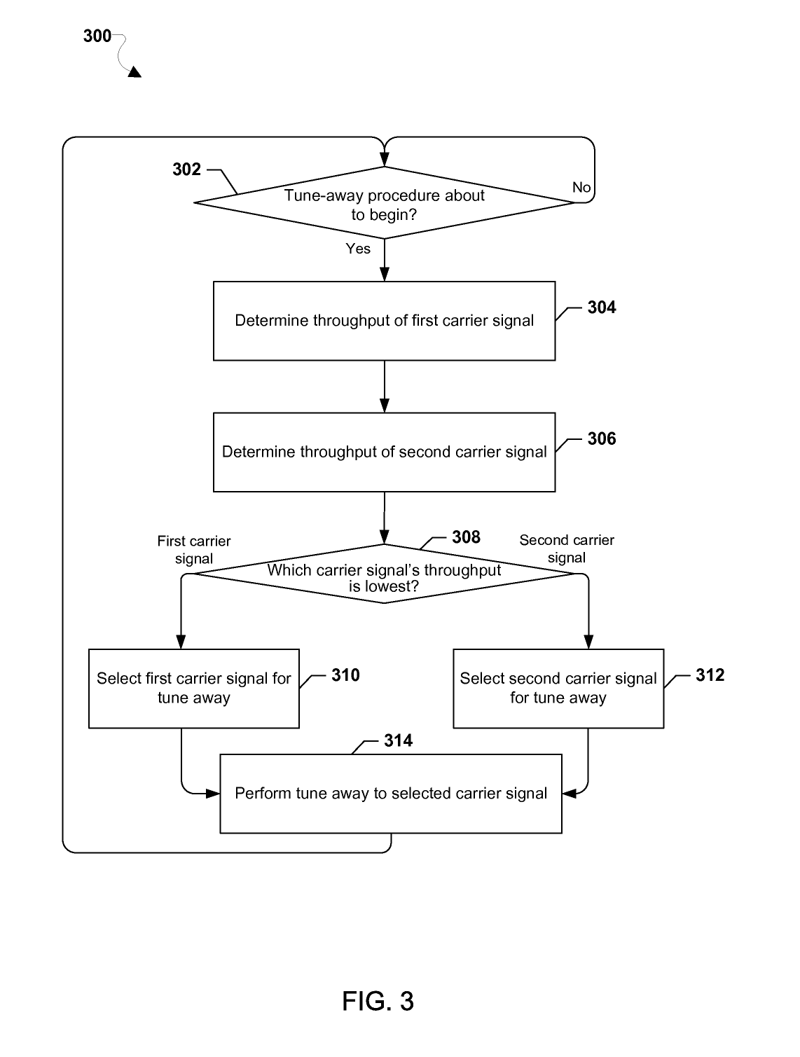

FIG. 3 illustrates a method 300 for managing tune away in a multi-subscription wireless device (e.g., the multi-subscription communication device 102, 200 in FIGS. 1-2) according to some embodiments. The method 300 may be implemented by a processor (e.g., the general purpose processor 206 of FIG. 2, the baseband processor 216, a separate controller, and/or the like) of the multi-subscription communication device.

With reference to FIGS. 1-3, in determination block 302, the multi-subscription communication device processor may determine whether a tune-away procedure is about to begin. In response to determining that a tune-away procedure is not about to begin (i.e., determination block 302=“No”), the multi-subscription communication device processor may continue to determine whether a tune-away procedure is about to begin in determination block 302.

In response to determining that a tune-away procedure is about to begin (i.e., determination block 302=“Yes”), the multi-subscription communication device processor may determine a throughput of a first carrier signal in block 304, and determine a throughput of a second carrier signal in block 306. Blocks 304 and 306 may be performed substantially simultaneously (e.g., in parallel) or in sequence. When more than two carrier signals are being used simultaneously (e.g., in LTE-Advanced), the throughput of each of the carrier signals may be determined substantially simultaneously or in sequence.

In some embodiments, the throughputs determined for the first and second carrier signals may include an instantaneous determination of throughput and/or a determination of throughput over time. For example, the multi-subscription communication device processor may determine a carrier signal throughput over a time interval, such as a period of seconds or milliseconds. The device processor may also determine a carrier signal throughput for a period of data transmission, such as a frame or subframe of data received by the multi-subscription communication device. For example, the device processor may determine a carrier signal throughput per time transmission interval (TTI). Other time periods, data lengths, or data transmission time periods may also be used. In some embodiments, the device processor may determine an average throughput for each carrier signal. The average throughput may include an average throughput over time and/or over a period of data transmission (e.g., over a moving time period of seconds, milliseconds, over a previous number of subframes or TTIs, or a similar moving period). The average throughput may include a moving average, an average over a designated period of time/data transmission interval, or another method of calculating an average throughput. That is, according to various embodiments, throughputs may be determined in any suitable manner.

In some embodiments in which carrier aggregation is used in the first and/or second carrier signals, the multi-subscription communication device processor may determine a throughput for each component carrier of the first and/or second carrier signals. The device processor may determine an aggregate throughput of a carrier signal based on the throughput of each component carrier, an average throughput based on the throughput of each component carrier, a mean throughput based on the throughput of each component carrier, or another determination of throughput using the determined throughput(s) of the component carriers of a carrier signal. In some embodiments, the device processor may determine a moving average throughput of each component carrier over a moving time period of seconds, milliseconds, over a previous number of subframes or TTIs, or a similar moving period.

The multi-subscription communication device processor may determine the throughput of each carrier signal based on a pilot signal, a received data channel, a received control channel, or another signal, including combinations of the foregoing. By determining the throughputs of the first and second carrier signals just prior to a tune-away procedure, the processor of the multi-subscription communication device may dynamically account for variations in carrier signal loading, data scheduling by the transmitter (e.g., base station 104 or 106), network conditions that may affect throughput, and other communication characteristics over time. Furthermore, the device processor may determine the throughputs of the first and second carrier signals independent of a signal strength, signal quality, or other signal characteristics that may, for example, vary with the RF environment.

In determination block 308, the multi-subscription communication device processor may identify the signal with the lowest throughput. While determination block 308 is shown as being as between the first carrier signal and the second carrier signal, the multi-subscription communication device processor may determine the signal having the lowest throughput from among all concurrent channels (e.g., up to five channels in LTE-Advanced), and therefore the references to the first and second carrier signals is not intended to be limiting.

In response to determining that the first carrier throughput is lowest (i.e., determination block 308=“first carrier signal”), the multi-subscription communication device processor may select the first carrier signal to use for performing the upcoming tune-away procedure in block 310. In response to determining that the second carrier throughput is lowest (i.e., determination block 308=“second carrier signal”), the multi-subscription communication device processor may select the second carrier signal to use for performing the upcoming tune-away procedure in block 312. Thus, according to various embodiments, the carrier signal having the lowest throughput is selected for tune away. In block 314, the multi-subscription communication device processor may perform the tune-away procedure using the selected carrier signal (i.e., using the identified lowest throughput carrier signal).

The multi-subscription communication device processor may again determine whether a tune-away procedure is about to begin in determination block 302 to repeat the method 300 during the next tune-away procedure. In this manner, the multi-subscription communication device may dynamically determine throughputs of the first and second carrier signals, and perform each tune-away procedure using the lowest throughput carrier signal of the two or more carrier signals. In various embodiments, using the lowest throughput carrier signal to perform the tune-away procedure may increase multi-subscription communication device performance by increasing the available bandwidth for communications.

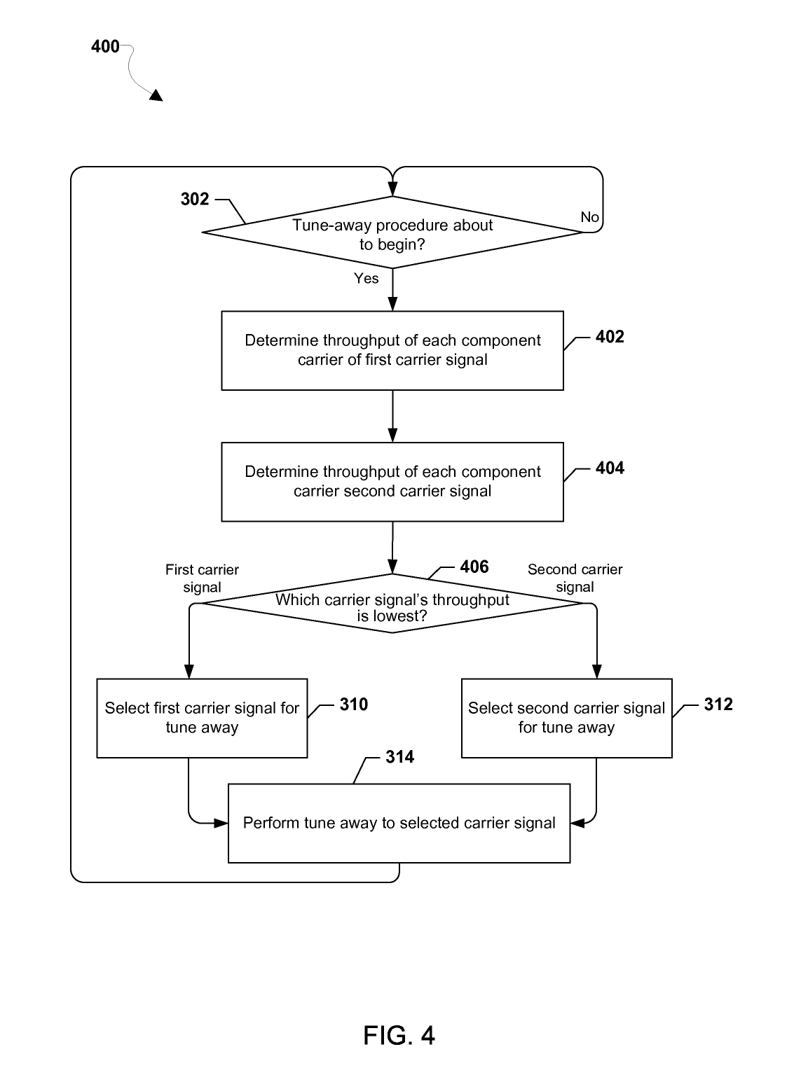

FIG. 4 illustrates a method 400 for managing tune away in a multi-subscription communication device (e.g., the multi-subscription communication device 102, 200 in FIGS. 1-2) according to some embodiments. The method 400 may be implemented by a processor (e.g., the general purpose processor 206 of FIG. 2, the baseband processor 216, a separate controller, and/or the like) of the multi-subscription communication device.

With reference to FIGS. 1-4, in determination block 302, as in the method 300, the multi-subscription communication device processor may determine whether a tune-away procedure is about to begin. In response to determining that a tune-away procedure is not about to begin (i.e., determination block 302=“No”), the multi-subscription communication device processor may continue to determine whether a tune-away procedure is about to begin in determination block 302.

In response to determining that a tune-away procedure is about to begin (i.e., determination block 302=“Yes”), the multi-subscription communication device processor may determine a throughput of each component carrier in a first carrier signal in block 402, and determine a throughput of each component carrier in a second carrier signal in block 404. Blocks 402 and 404 may be performed substantially simultaneously (e.g., in parallel) or in sequence. When more than two carrier signals are being used simultaneously (e.g., in LTE-Advanced), the throughput of each of the carrier signals may be determined at substantially simultaneously or in sequence.

In some embodiments, the throughputs determined for the first and second component carrier signals may include an instantaneous determination of throughput or a determination of throughput over time. For example, the multi-subscription communication device processor may determine a component carrier signal throughput over a time interval, such as a period of milliseconds. The device processor may also determine a component carrier signal throughput for a period of data transmission, such as a frame or subframe of data received by the multi-subscription communication device. For example, the device processor may determine a component carrier signal throughput per time transmission interval (TTI). Other time periods, data lengths, or data transmission time periods may also be used. In some embodiments, the device processor may determine an average throughput for each carrier signal. The average throughput may include an average throughput over time and/or over a period of data transmission (e.g., over a moving time period of second, milliseconds, over a previous number of subframes or TTIs, or a similar moving period). The average throughput may include a moving average, an average over a designated period of time/data transmission interval, or another method of calculating an average throughput. That is, according to various embodiments, throughputs may be determined in any suitable manner.

In some embodiments in which carrier aggregation is used in the first and/or second carrier signals, the multi-subscription communication device processor may determine a throughput for each component carrier of the first and/or second carrier signals. The device processor may determine an aggregate throughput of a carrier signal based on the throughput of each component carrier, an average throughput based on the throughput of each component carrier, a mean throughput based on the throughput of each component carrier, or another determination of throughput using the determined throughput(s) of the component carriers of a carrier signal. In some embodiments, the device processor may determine a moving average throughput of each component carrier over a moving time period of seconds, milliseconds, over a previous number of subframes or TTIs, or a similar moving period. In some embodiments, determining a first throughput of a first carrier signal and a second throughput of a second carrier signal may include determining a first throughput per TTI for the first carrier signal and determining a second throughput per TTI for the second carrier signal. In some embodiments, determining a first throughput of a first carrier signal and a second throughput of a second carrier signal may include determining a first average throughput per TTI for each component carrier of the first carrier signal and determining a second average throughput per TTI for each component carrier of the second carrier signal.

In determination block 406, the multi-subscription communication device processor may identify the carrier signal with the lowest throughput component carrier. In response to determining that the first carrier signal includes the lowest throughput (i.e., determination block 406=“first carrier signal”), the processor may select the first carrier signal to use for performing the upcoming tune-away procedure in block 310, as in the method 300. In response to determining that the second carrier signal includes the lowest throughput (i.e., determination block 406 =“second carrier signal”), the processor may select the second carrier signal to use for performing the upcoming tune-away procedure in block 312, as in the method 300. Thus, according to various embodiments, the carrier signal having the lowest throughput component carrier is selected for tune away. Similar to the method 300, in block 314, the processor may perform the tune-away procedure using the selected carrier signal.

The multi-subscription communication device processor may again determine whether a tune-away procedure is about to begin in determination block 302 to repeat the method 400 for the next tune-away procedure. In this manner, the multi-subscription communication device may dynamically determine the throughputs of the component carriers of the first and second carrier signals, and perform each tune-away procedure using the carrier with the lowest throughput based on the determined throughputs of each carrier signal's component carriers.

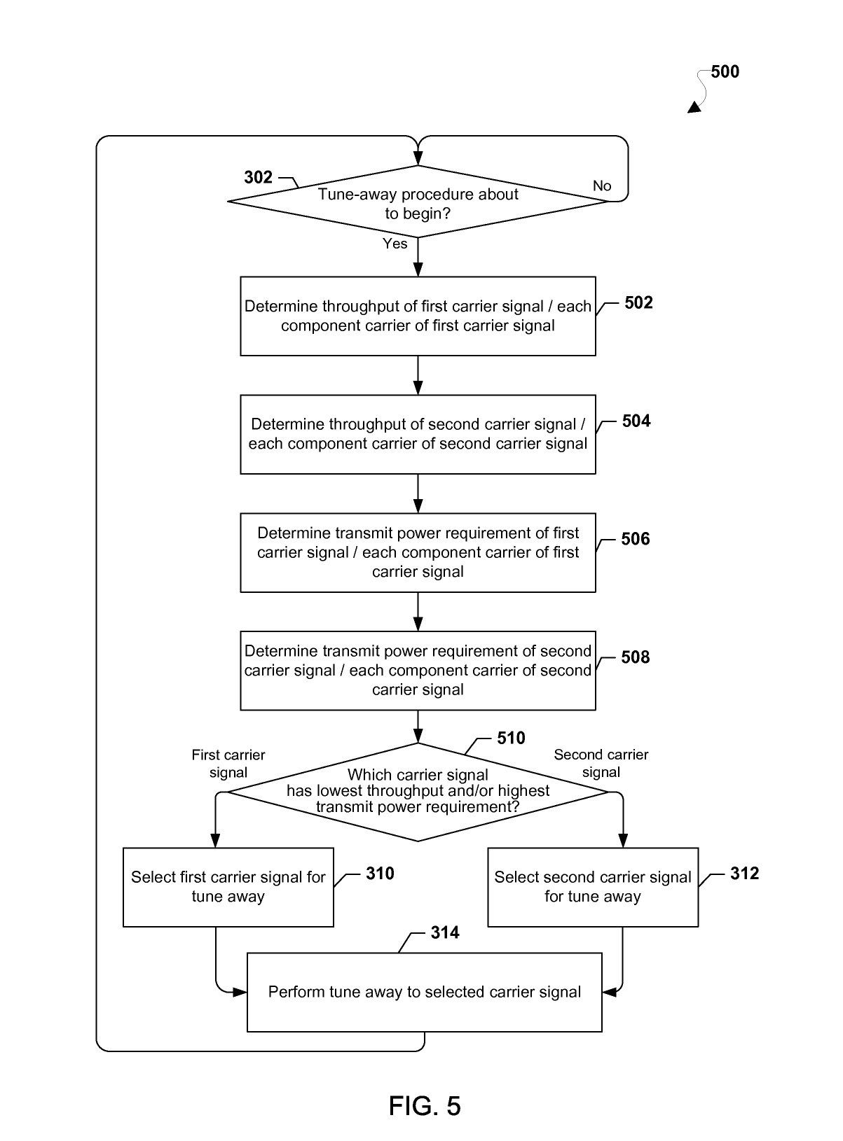

FIG. 5 illustrates a method 500 for managing tune away in a multi-subscription communication device (e.g., the multi-subscription communication device 102,200 in FIGS. 1-2) according to some embodiments. The method 500 may be implemented by a processor (e.g., the general purpose processor 206 of FIG. 2, the baseband processor 216, a separate controller, and/or the like) of the multi-subscription communication device.

With reference to FIGS. 1-5, in determination block 302, as in the methods 300 and 400, the multi-subscription communication device processor may determine whether a tune-away procedure is about to begin. In response to determining that a tune-away procedure is not about to begin (i.e., determination block 302=“No”), the multi-subscription communication device processor may continue to determine whether a tune-away procedure is about to begin in determination block 302.

In response to determining that a tune-away procedure is about to begin (i.e., determination block 302=“Yes”), the multi-subscription communication device processor may determine a throughput of a first carrier signal or of each component carrier in the first carrier signal in block 502, and may determine a throughput of a second carrier signal or of each component carrier in the second carrier signal in block 504, as in the methods 300 and 400. Blocks 502 and 504 may be performed substantially simultaneously (e.g., in parallel) or in sequence. When more than two carrier signals are being used simultaneously (e.g., in LTE-Advanced), the throughput of each of the carrier signals (or of each component carrier of each carrier signal) may be determined at the same time.

In block 506, the multi-subscription communication device processor may determine a transmit power requirement of the first carrier signal or of each component carrier in the first carrier signal. In block 508, the multi-subscription communication device processor may determine a transmit power requirement of the second carrier signal or of each component carrier in the second carrier signal. The multi-subscription communication device processor may determine the transmit power requirements of the first and second carrier signals in a variety of ways. For example, the device processor may determine the transmit power requirements based on a ranging process between the multi-subscription communication device and a base station or access point (e.g., base station 104 or 106). As another example, the device processor may determine the transmit power requirements based on response(s) to one or more access probes sent by the multi-subscription communication device to the base station/access point. As another example, the transmit power requirement may be dictated to the multi-subscription communication device by the base station/access point and/or by the particular RAT used for communication between the multi-subscription communication device and the base station/access point. As another example, the transmit power requirement may also be negotiated between the multi-subscription communication device and the base station/access point during a negotiation over communication resource allocation between the multi-subscription communication device and the base station/access. Blocks 506 and 508 may be performed substantially simultaneously (e.g., in parallel) or in sequence.

In determination block 510, the multi-subscription communication device processor may identify the carrier signal with the lowest throughput or the highest transmit power requirement. In response to determining that the first carrier signal includes the lowest throughput or the highest transmit power requirement (i.e., determination block 510=“first carrier signal”), the processor may select the first carrier signal to use for performing the upcoming tune-away procedure in block 310, as in the method 300. In response to determining that the second carrier signal includes the lowest throughput or the highest transmit power requirement (i.e., determination block 510=“second carrier signal”), the processor may select the second carrier signal to use for performing the upcoming tune-away procedure in block 312, as in the method 300. Thus, in some embodiments, the carrier signal with the lowest throughput is selected. In some embodiments, the carrier signal with highest transmit power requirement is selected. In some embodiments, the carrier signal with at least one of the lowest throughput and the highest transmit power requirement is selected. Similar to the method 300, in block 314, the processor may perform the tune-away procedure using the selected carrier signal.

The multi-subscription communication device processor may again determine whether a tune-away procedure is about to begin in determination block 302 to repeat the method 500 for the next tune-away procedure. In this manner, the multi-subscription communication device may dynamically determine the throughputs of each carrier signal and/or the component carriers of the first and second carrier signals, and perform each tune-away procedure using the carrier signal with the lowest throughput and the highest transmit power requirement based on the determined throughputs and/or transmit power requirements of each carrier signal and/or each carrier signal's component carriers.

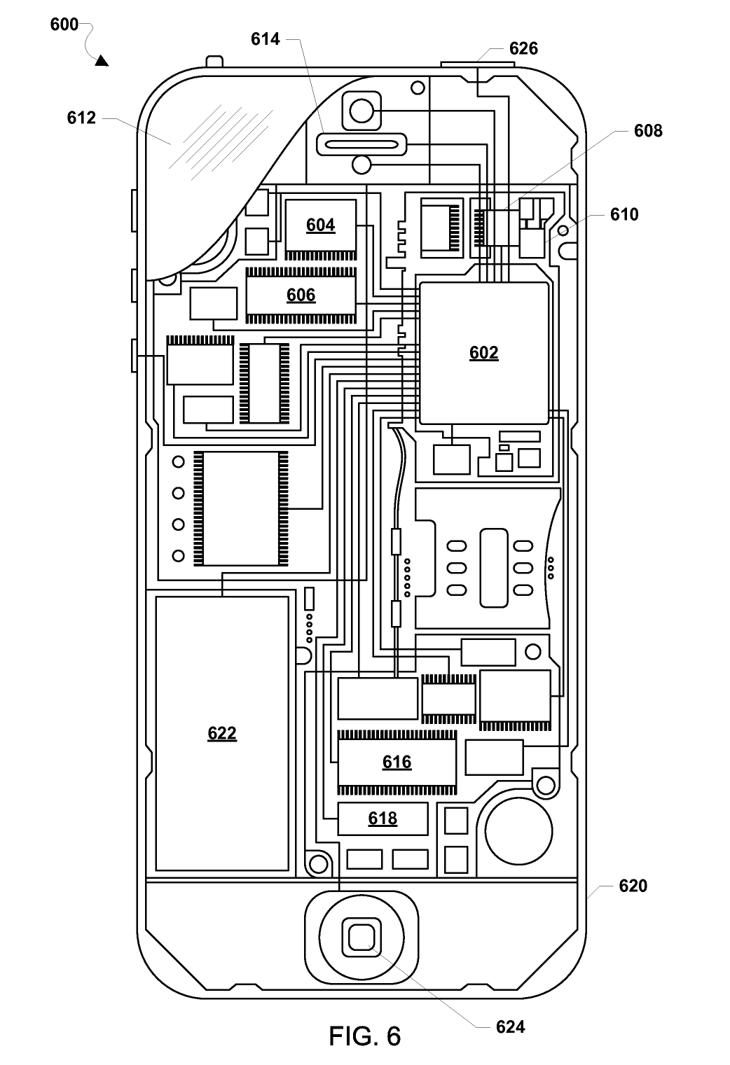

Various embodiments (including, but not limited to, embodiments discussed above with reference to FIGS. 3-5) may be implemented in any of a variety of mobile communication devices, an example of which (e.g., mobile communication device 600) is illustrated in FIG. 6. In various embodiments, the mobile communication device 600 (which may correspond, for example, to the multi-subscription communication devices 102 and 200 in FIGS. 1-2) may include a processor 602 coupled to a touchscreen controller 604 and an internal memory 606. The processor 602 may be one or more multi-core integrated circuits designated for general or specific processing tasks. The internal memory 606 may be volatile or non-volatile memory, and may also be secure and/or encrypted memory, or unsecure and/or unencrypted memory, or any combination thereof. The touchscreen controller 604 and the processor 602 may also be coupled to a touchscreen panel 612, such as a resistive-sensing touchscreen, capacitive-sensing touchscreen, infrared sensing touchscreen, etc. Additionally, the display of the mobile communication device 600 need not have touch screen capability.

The mobile communication device 600 may have two or more radio signal transceivers 608 (e.g., Peanut, Bluetooth, Zigbee, Wi-Fi, RF radio) and antennae 610, for sending and receiving communications, coupled to each other and/or to the processor 602. The transceivers 608 and antennae 610 may be used with the above-mentioned circuitry to implement the various wireless transmission protocol stacks and interfaces. The mobile communication device 600 may include one or more cellular network wireless modem chip(s) 616 coupled to the processor and antennae 610 that enables communication via two or more cellular networks via two or more radio access technologies.

The mobile communication device 600 may include a peripheral device connection interface 618 coupled to the processor 602. The peripheral device connection interface 618 may be singularly configured to accept one type of connection, or may be configured to accept various types of physical and communication connections, common or proprietary, such as USB, FireWire, Thunderbolt, or PCIe. The peripheral device connection interface 618 may also be coupled to a similarly configured peripheral device connection port (not shown).

The mobile communication device 600 may also include speakers 614 for providing audio outputs. The mobile communication device 600 may also include a housing 620, constructed of a plastic, metal, or a combination of materials, for containing all or some of the components discussed herein. The mobile communication device 600 may include a power source 622 coupled to the processor 602, such as a disposable or rechargeable battery. The rechargeable battery may also be coupled to the peripheral device connection port to receive a charging current from a source external to the mobile communication device 600. The mobile communication device 600 may also include a physical button 624 for receiving user inputs. The mobile communication device 600 may also include a power button 626 for turning the mobile communication device 600 on and off.

The processor 602 may be any programmable microprocessor, microcomputer or multiple processor chip or chips that can be configured by software instructions (applications) to perform a variety of functions, including the functions of various embodiments described below. In some mobile communication devices, multiple processors 602 may be provided, such as one processor dedicated to wireless communication functions and one processor dedicated to running other applications. Typically, software applications may be stored in the internal memory 606 before they are accessed and loaded into the processor 602. The processor 602 may include internal memory sufficient to store the application software instructions.

Various embodiments may be implemented in any number of single or multi-processor systems. Generally, processes are executed on a processor in short time slices so that it appears that multiple processes are running simultaneously on a single processor. When a process is removed from a processor at the end of a time slice, information pertaining to the current operating state of the process is stored in memory so the process may seamlessly resume its operations when it returns to execution on the processor. This operational state data may include the process's address space, stack space, virtual address space, register set image (e.g., program counter, stack pointer, instruction register, program status word, etc.), accounting information, permissions, access restrictions, and state information.

A process may spawn other processes, and the spawned process (i.e., a child process) may inherit some of the permissions and access restrictions (i.e., context) of the spawning process (i.e., the parent process). A process may be a heavy-weight process that includes multiple lightweight processes or threads, which are processes that share all or portions of their context (e.g., address space, stack, permissions and/or access restrictions, etc.) with other processes/threads. Thus, a single process may include multiple lightweight processes or threads that share, have access to, and/or operate within a single context (i.e., the processor's context).

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the spirit or scope of the embodiments. Thus, the various embodiments are not intended to be limited to the embodiments shown herein but are to be accorded the widest scope consistent with the following claims and the principles and novel features disclosed herein.

What is claimed is:

1. A method for managing tune away in a multi-subscription communication device having a plurality of radio frequency (RF) resources, the method comprising:
determining, by the multi-subscription communication device, a first throughput of a first carrier signal and a second throughput of a second carrier signal; and
performing, by the multi-subscription communication device, a tune-away procedure to a carrier signal determined to have a lower throughput from among the first carrier signal and the second carrier signal.

2. The method of claim 1, wherein determining a first throughput of a first carrier signal and a second throughput of a second carrier signal comprises determining the first throughput and the second throughput just prior to the tune-away procedure.

3. The method of claim 1, wherein determining a first throughput of a first carrier signal and a second throughput of a second carrier signal is independent of a signal strength of either the first carrier signal or the second carrier signal.

4. The method of claim 1, wherein determining a first throughput of a first carrier signal and a second throughput of a second carrier signal comprises determining a first throughput for each component carrier of the first carrier signal and determining a second throughput for each component carrier of the second carrier signal, respectively.

5. The method of claim 1, wherein determining a first throughput of a first carrier signal and a second throughput of a second carrier signal comprises determining a first average throughput of the first carrier signal and determining a second average throughput of the second carrier signal, respectively.

6. The method of claim 1, wherein determining a first throughput of a first carrier signal and a second throughput of a second carrier signal comprises determining a first average throughput for each component carrier of the first carrier signal and determining a second average throughput for each component carrier of the second carrier signal, respectively.

7. The method of claim 1, wherein determining a first throughput of a first carrier signal and a second throughput of a second carrier signal comprises determining a first throughput per time transmission interval (TTI) for the first carrier signal and determining a second throughput per TTI for the second carrier signal, respectively.

8. The method of claim 7, wherein determining a first throughput per TTI for the first carrier signal and determining a second throughput per TTI for the second carrier signal comprises determining a first average throughput per TTI for each component carrier of the first carrier signal and determining a second average throughput per TTI for each component carrier of the second carrier signal respectively.

9. The method of claim 1, further comprising:
determining, by the multi-subscription communication device, a first transmit power requirement of the first carrier signal and a second transmit power requirement of the second carrier signal,
wherein performing, by the multi-subscription communication device, a tune-away procedure to a carrier signal determined to have a lower throughput from among the first carrier signal and the second carrier signal comprises performing, by the multi-subscription communication device, a tune-away procedure to a carrier signal determined to have at least one of a lower throughput and a higher transmit power requirement from among the first carrier signal and the second carrier signal.

10. A multi-subscription communication device, comprising:
a plurality of radio frequency (RF) resources; and
a processor coupled to the plurality of RF resources, wherein the processor is configured to:
determine a first throughput of a first carrier signal and a second throughput of a second carrier signal; and
perform a tune-away procedure to a carrier signal determined to have a lower throughput from among the first carrier signal and the second carrier signal.

11. The multi-subscription communication device of claim 10, wherein the processor is further configured to determine the first throughput and the second throughput just prior to the tune-away procedure.

12. The multi-subscription communication device of claim 10, wherein the processor is further configured to determine a first throughput of a first carrier signal and a second throughput of a second carrier signal independent of a signal strength of either the first carrier signal or the second carrier signal.

13. The multi-subscription communication device of claim 10, wherein the processor is further configured to determine a first throughput for each component carrier of the first carrier signal and determining a second throughput for each component carrier of the second carrier signal, respectively.

14. The multi-subscription communication device of claim 10, wherein the processor is further configured to determine a first average throughput of the first carrier signal and determining a second average throughput of the second carrier signal, respectively.

15. The multi-subscription communication device of claim 10, wherein the processor is further configured to determine a first average throughput for each component carrier of the first carrier signal and determining a second average throughput for each component carrier of the second carrier signal, respectively.

16. The multi-subscription communication device of claim 10, wherein the processor is further configured to determine a first throughput per time transmission interval (TTI) for the first carrier signal and determining a second throughput per TTI for the second carrier signal, respectively.

17. The multi-subscription communication device of claim 16, wherein the processor is further configured to determine a first average throughput per TTI for each component carrier of the first carrier signal and determining a second average throughput per TTI for each component carrier of the second carrier signal, respectively.

18. The multi-subscription communication device of claim 10, wherein the processor is further configured to:
determine a first transmit power requirement of the first carrier signal and a second transmit power requirement of the second carrier signal; and
perform a tune-away procedure to a carrier signal having at least one of a lower throughput and a higher transmit power requirement from among the first carrier signal and the second carrier signal.

19. A multi-subscription communication device, comprising:
a plurality of radio frequency (RF) resources;
means for determining a first throughput of a first carrier signal and a second throughput of a second carrier signal; and
means for performing a tune-away procedure to a carrier signal having a lower throughput from among the first carrier signal and the second carrier signal.

20. A non-transitory processor-readable storage medium having stored thereon processor-executable instructions configured to cause a processor of a multi-subscription communication device having at least a plurality of radio frequency (RF) resources to perform operations comprising:
determining a first throughput of a first carrier signal and a second throughput of a second carrier signal; and
performing a tune-away procedure to a carrier signal determined to have a lower throughput from among the first carrier signal and the second carrier signal.

21. The non-transitory processor-readable storage medium of claim 20, wherein the stored processor-executable instructions configured to cause a processor of a multi-subscription communication device to perform operations such that determining a first throughput of a first carrier signal and a second throughput of a second carrier signal comprises determining the first throughput and the second throughput just prior to the tune-away procedure.

22. The non-transitory processor-readable storage medium of claim 20, wherein the stored processor-executable instructions configured to cause a processor of a multi-subscription communication device to perform operations such that determining a first throughput of a first carrier signal and a second throughput of a second carrier signal is independent of a signal strength of either the first carrier signal or the second carrier signal.

23. The non-transitory processor-readable storage medium of claim 20, wherein the stored processor-executable instructions configured to cause a processor of a multi-subscription communication device to perform operations such that determining a first throughput of a first carrier signal and a second throughput of a second carrier signal comprises determining a first throughput for each component carrier of the first carrier signal and determining a second throughput for each component carrier of the second carrier signal, respectively.

24. The non-transitory processor-readable storage medium of claim 20, wherein the stored processor-executable instructions configured to cause a processor of a multi-subscription communication device to perform operations such that determining a first throughput of a first carrier signal and a second throughput of a second carrier signal comprises determining a first average throughput of the first carrier signal and determining a second average throughput of the second carrier signal, respectively.

25. The non-transitory processor-readable storage medium of claim 20, wherein the stored processor-executable instructions configured to cause a processor of a multi-subscription communication device to perform operations such that determining a first throughput of a first carrier signal and a second throughput of a second carrier signal comprises determining a first average throughput for each component carrier of the first carrier signal and determining a second average throughput for each component carrier of the second carrier signal, respectively.

26. The non-transitory processor-readable storage medium of claim 20, wherein the stored processor-executable instructions configured to cause a processor of a multi-subscription communication device to perform operations such that determining a first throughput of a first carrier signal and a second throughput of a second carrier signal comprises determining a first throughput per time transmission interval (TTI) for the first carrier signal and determining a second throughput per TTI for the second carrier signal.

27. The non-transitory processor-readable storage medium of claim 26, wherein the stored processor-executable instructions configured to cause a processor of a multi-subscription communication device to perform operations such that determining a first throughput per TTI for the first carrier signal and determining a second throughput per TTI for the second carrier signal comprises determining a first average throughput per TTI for each component carrier of the first carrier signal and determining a second average throughput per TTI for each component carrier of the second carrier signal.

28. The non-transitory processor-readable storage medium of claim 20, wherein the stored processor-executable instructions configured to cause a processor of a multi-subscription communication device to perform operations further comprising:
determining, by the multi-subscription communication device, a first transmit power requirement of the first carrier signal and a second transmit power requirement of the second carrier signal;
wherein performing, by the multi-subscription communication device, a tune-away procedure to a carrier signal determined to have a lower throughput from among the first carrier signal and the second carrier signal comprises performing, by the multi-subscription communication device, a tune-away procedure to a carrier signal determined to have at least one of a lower throughput and a higher transmit power requirement from among the first carrier signal and the second carrier signal.
